(19) United States
(12) Patent Application Publication
(10) Pub. No.: US 2025/0336187 A1
(43) Pub. Date: Oct. 30, 2025

(54) INFORMATION PROCESSING DEVICE, METHOD FOR CONTROLLING INFORMATION PROCESSING DEVICE, AND PROGRAM

(71) Applicant: CANON KABUSHIKI KAISHA, Tokyo (JP)

(72) Inventors: TOMONORI YAZAWA, Kanagawa (JP); SHUNTA TATE, Tokyo (JP)

(21) Appl. No.: 19/264,042

(22) Filed: Jul. 9, 2025

Related U.S. Application Data
(63) Continuation of application No. PCT/JP2023/045317, filed on Dec. 18, 2023.

(30) Foreign Application Priority Data
Jan. 13, 2023 (JP) 2023-003675

(51) Int. Cl. G06V 10/77; G06V 10/62; G06V 10/80; G06V 10/82; G06V 40/16

(52) U.S. Cl. CPC G06V 10/7715; G06V 10/62; G06V 10/806; G06V 10/82; G06V 40/171; G06V 40/172

(57) ABSTRACT

An information processing device includes an acquirer and a feature extractor. The acquirer is configured to acquire a feature sequence from each image in a plurality of images containing a common object. The feature extractor is configured to extract representative features of the object in the plurality of images from the feature sequence acquired by the acquirer. The acquirer is configured to acquire the feature sequence based on intra-image information within each image in the plurality of images and inter-image information across the plurality of images.

### CROSS-REFERENCE TO RELATED APPLICATIONS

This application is a Continuation of International Patent Application No. PCT/JP2023/045317, filed Dec. 18, 2023, which claims the benefit of Japanese Patent Application No. 2023-003675, filed Jan. 13, 2023, both of which are hereby incorporated by reference herein in their entirety.

### BACKGROUND

### Field of the Technology

The present disclosure relates in particular to an information processing device, a method for controlling an information processing device, and a program favorably used to extract features from images.

### Description of the Related Art

In recent years, technologies have been proposed to process captured images of objects to extract useful information. In particular, research is actively pursuing technologies that use multilayer neural networks called deep nets (or deep neural nets, deep learning). One disclosed technology uses a deep net to transform face images into features for matching processing, and is designed to perform the matching processing with high accuracy by imposing constraints to increase the distance between face images of the same person and face images of other persons during training (see Jiankang Deng, Jia Guo, Niannan Xue, Stefanos Zafeiriou, ArcFace: Additive Angular Margin Loss for Deep Face Recognition, arXiv: 1801.07698; hereinafter referred to as document 1). However, with the technique indicated in document 1, the accuracy of the matching processing is lowered for low-quality and/or noisy images.

### SUMMARY

The present disclosure has been prepared in light of the above, and an objective thereof is to enable the extraction of features that are effective for a matching process from low-quality and/or noisy images.

An information processing device according to the present disclosure includes an acquirer and a feature extractor. The acquirer is configured to acquire a feature sequence from each image in a plurality of images containing a common object. The feature extractor is configured to extract representative features of the object in the plurality of images from the feature sequence acquired by the acquirer. The acquirer is configured to acquire the feature sequence based on intra-image information within each image in the plurality of images and inter-image information across the plurality of images.

Features of the present disclosure will become apparent from the following description of exemplary embodiments with reference to the attached drawings.

### BRIEF DESCRIPTION OF THE DRAWINGS

FIG. 1 is a block diagram illustrating an example of the functional configuration of an information processing device according to a first embodiment.

FIG. 2 is a flowchart illustrating an example of a processing procedure of a matching process.

FIG. 3 is a block diagram illustrating an example of the functional configuration of an information processing device according to a second embodiment.

FIG. 4 is a flowchart illustrating an example of a processing procedure of a training process.

FIG. 5 is a diagram schematically illustrating a portion of an attention process according to the first embodiment.

FIG. 6 is a diagram schematically illustrating a portion of an attention process in modification 1.

FIG. 7 is a diagram schematically illustrating organ detection results for face images.

FIG. 8 is a diagram schematically illustrating an organ position matrix.

FIG. 9 is a diagram schematically illustrating a process using an aggregate token sequence.

FIG. 10 is a diagram schematically illustrating a process in a case where multiple images are divided up and inputted in multiple batches in a process using an aggregate token sequence.

FIG. 11 is a block diagram illustrating an example of the hardware configuration of an information processing device.

### DESCRIPTION OF THE EMBODIMENTS

Hereinafter, the present disclosure will be described in detail on the basis of preferred embodiments, with reference to the attached drawings. Note that the configurations indicated in the following embodiment are merely examples, and the present disclosure is not limited to the configurations illustrated in the drawings.

### First Embodiment

In the present embodiment, features that account for not only intra-image attention but also inter-image attention are generated using multiple images during a deep net matching process. Information is extracted in a complementary manner, even from multiple images containing noise or the like, and features that are effective for the matching process are generated. Note that inter-image attention is assumed to process locations where corresponding image coordinates in each of multiple images are close together.

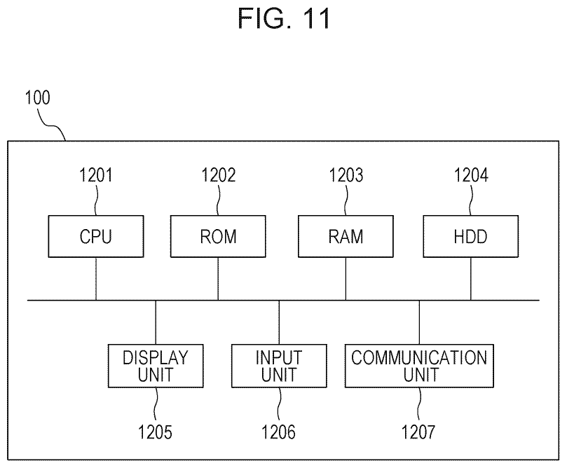

FIG. 11 is a block diagram illustrating an example of the hardware configuration of an information processing device 100 according to the present embodiment. The information processing device 100 includes a CPU 1201, ROM 1202, RAM 1203, an HDD 1204, a display unit 1205, an input unit 1206, and a communication unit 1207.

The CPU 1201 executes various processes by reading out a control program stored in the ROM 1202. The RAM 1203 is used as a temporary storage area, such as a main memory or a work area of the CPU 1201. The HDD 1204 stores various data, various programs, and the like. The display unit 1205 displays various information. The input unit 1206 includes a keyboard and/or a mouse and accepts various operations performed by a user. The communication unit 1207 performs a process for communicating with an external device such as an image forming device over a network. As another example, the communication unit 1207 may communicate wirelessly with an external device.

Note that the functions and/or processes of the information processing device 100 described later are achieved by having the CPU 1201 read out a program stored in the ROM 1202 or the HDD 1204 and execute the program. As another example, the CPU 1201 may read out a program stored in a recording medium such as an SD card instead of the ROM 1202 or the like.

In the present embodiment, the information processing device 100 is assumed to have a single processor (the CPU 1201) that uses a single memory (the ROM 1202) to execute the processes illustrated in the flowcharts described later, but the information processing device 100 may be configured differently. For example, multiple processors and multiple RAM, ROM, and/or storage modules may cooperate to execute the processes illustrated in the flowcharts described later. Hardware circuitry may also be used to execute some of the processes. A processor other than a CPU may also be used to achieve the functions and/or processes of the information processing device 100 described later. For example, a graphics processing unit (GPU) may be used instead of a CPU.

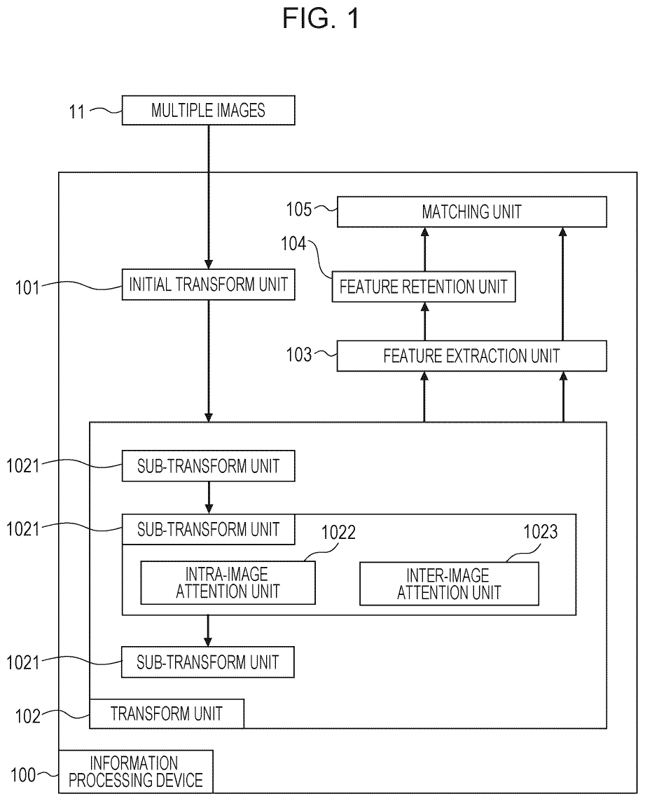

FIG. 1 is a block diagram illustrating an example of the functional configuration of the information processing device 100 according to the present embodiment. An initial transform unit 101 transforms multiple images 11 into a feature sequence. In the present embodiment, a transform process is performed by a deep net included in the initial transform unit 101. In this context, the multiple images 11 are multiple images showing the face of a person as an example of an object, and are, for example, multiple images of regions estimated to be the face of a person that are obtained from video by using face detection and tracking. In the case of generating multiple images 11 containing the face of the same person by face detection and tracking face detection is performed according to the method described in Jiankang Deng, Jia Guo, Yuxiang Zhou, Jinke Yu, Irene Kotsia, Stefanos Zafeiriou, RetinaFace: Single-stage Dense Face Localisation in the Wild, arXiv: 1905.00641 (hereinafter referred to as document 3), and tracking is performed according to the method described in Bo Li, Wei Wu, Qiang Wang, Fangyi Zhang, Junliang Xing, Junjie Yan, SiamRPN+++: Evolution of Siamese Visual Tracking with Very Deep Networks, arXiv: 1812.11703 (hereinafter referred to as document 4), for example. The multiple images 11 may also be generated by acquiring images estimated to be the face of the same person from multiple cameras (for example, estimated to be the same person based on camera placement or the movement of the person) according to the method described in document 3. The initial transform unit 101 also simultaneously inputs information on whether the multiple images 11 are to be used in a retention process or a comparison process in subsequent processing.

The transform unit 102 accepts the input of the feature sequence transformed by the initial transform unit 101, and outputs a newly generated feature sequence. In the present embodiment, the process of generating a new feature sequence is performed by a deep net included in the transform unit 102. The deep net included in the transform unit 102 has one or more sub-transform units 1021 that each accept a feature sequence as input and output a newly generated feature sequence, to which the next unit is then applied in succession. In the present embodiment, the transform unit 102 is based on the Vision Transformer structure described in Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, Jakob Uszkoreit, Neil Houlsby, AN IMAGE IS WORTH 16X16 WORDS: TRANSFORMERS FOR IMAGE RECOGNITION AT SCALE, arXiv: 2010.11929 (hereinafter referred to as document 2), and each sub-transform unit 1021 is a structure corresponding to one sub-module included in the Vision Transformer encoder.

In the present embodiment, an intra-image attention unit 1022 and an inter-image attention unit 1023 replace the self-attention process described in document 2.

The feature extraction unit 103 accepts the input of a feature sequence, and generates and outputs features. In the present embodiment, a deep net is used to generate representative features for identifying an individual shown in an image. Note that the initial transform unit 101, the transform unit 102, and the feature extraction unit 103 are trained in advance so as to be capable of calculating similarities between features by taking the inner product, in accordance with the method using a deep net described in Jiankang Deng, Jia Guo, Niannan Xue, Stefanos Zafeiriou, ArcFace: Additive Angular Margin Loss for Deep Face Recognition, arXiv: 1801.07698. Training a deep net means adjusting parameters of the deep net to satisfy correspondence relations between inputs and outputs that have been prepared as labeled training data.

The feature retention unit 104 retains features corresponding to the face of a person for use in individual matching processing. The feature retention unit 104 performs the process to retain features when multiple images 11 are inputted into the initial transform unit 101 to perform the retention process.

When an image is inputted into the initial transform unit 101 to perform the comparison process, the matching unit 105 compares features of the image to the features retained by the feature retention unit 104, determines whether the features of the image match with any of the retained features, and obtains a matching result.

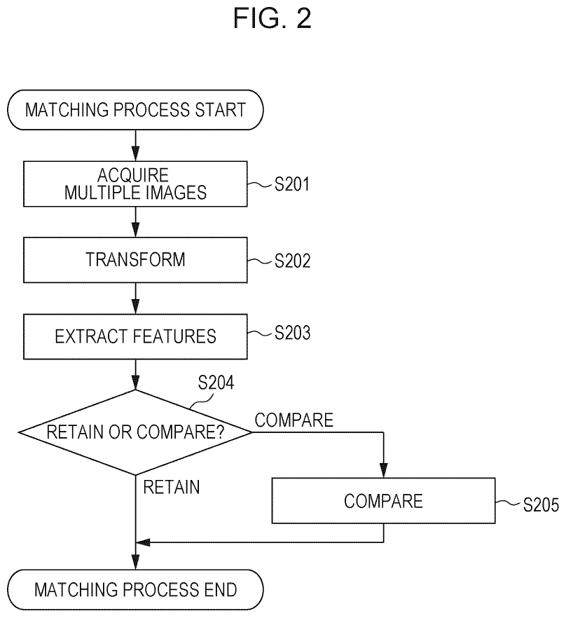

FIG. 2 is a flowchart illustrating an example of a processing procedure of the matching process by the information processing device 100 in the present embodiment. In S201, the initial transform unit 101 performs a process to acquire the multiple images 11. The initial transform unit 101 also acquires information about whether the acquired multiple images 11 are to be used in the retention process or the comparison process. Note that in the case where the multiple images 11 are to be used in the retention process, the following process is performed to retain features against which to make a similarity comparison. On the other hand, in the case where the multiple images 11 are to be used in the comparison process, a process is performed to match the person shown in the multiple images 11 by comparison between features generated from the multiple images 11 and the retained features.

In S202, the initial transform unit 101 and the transform unit 102 transform the multiple images 11 acquired in S201 into feature sequences. This process is performed by the deep nets included in the initial transform unit 101 and the transform unit 102, respectively.

First, the initial transform unit 101 transforms each image into a feature sequence and uses these feature sequences to generate a feature sequence corresponding to the multiple images 11 in entirety. In a manner similar to the method described in document 2, the initial transform unit 101 divides each image into regions of fixed size (16×16, for example) and applies a linear transform to each region to transform the regions into features. Note that the transform at this point may be a transform into features using ResNet50 as described in document 2. The parameters of the linear transform are parameters of the deep nets of the transform unit 102 and the feature extraction unit 103, and are optimized during training. The initial transform unit 101 outputs the feature sequence obtained by the transform to the transform unit 102.

Next, the transform unit 102 generates a new feature sequence by applying the sub-transform units 1021 in succession to the feature sequence inputted from the initial transform unit 101. In the present embodiment, since the transform unit 102 forms the Vision Transformer structure as a base, a feature sequence is inputted into each encoder sub-module (each of the sub-transform units 1021) in turn.

An intra-image attention unit 1022 and an inter-image attention unit 1023 of each sub-transform unit 1021 perform a modified process on the input of the self-attention softmax function (hereinafter referred to as the matrix QK) described in document 2. In the method described in document 2, the matrix QK is represented by expressions (1) to (3) below using X, which represents the feature sequence that serves as the input into the attention layer.

$$Q = {W}_{Q} X \qquad ( 1 )$$

$$K = {W}_{K} X \qquad ( 2 )$$

$$( QK ) = {QK}^{t} \qquad ( 3 )$$

In expression 1, W_{Q} and W_{K} each represent a matrix with learnable parameters. The self-attention softmax function is represented by expressions (4) and (5) below.

$$V = {W}_{V} X \qquad ( 4 )$$

$$softmax ( \frac{( QK )}{\sqrt{d}} ) V \qquad ( 5 )$$

In expression 2, W_{V} represents a matrix with learnable parameters. Also, d represents the number of rows in the matrix W_{K}.

In document 2, the matrix QK is processed by multiple heads and is referred to as multihead self-attention. The processes described below apply to all of the heads. The matrix QK is a matrix obtained by multiplying the query and key matrices of the Vision Transformer, with each row and each column of the matrix QK corresponding to one of the features included in the feature sequence of the input. In other words, provided that N is the number of features included in the feature sequence, the matrix QK is an N×N matrix. In the following, (QK)_{(i, x, y)(j, u, v)} is assumed to represent the element in the row corresponding to the feature for the region of fixed size at the coordinates (x, y) in the i-th image and in the column corresponding to the feature for the region of fixed size at the coordinates (u, v) coordinates in the j-th image.

In the present embodiment, the intra-image attention unit 1022 performs intra-image related processing. That is, processing is performed on the elements of (QK)_{(i, x, y)(j, u, v)} for which i=j. In the present embodiment, a matrix QKᵢₙₜᵣₐ representing intra-image attention is defined by the following expression (6).

$$\{ \begin{matrix}{( {QK}_{intra} )}_{( i , x , y ) j , u , ν )} = {( QK )}_{( i , x , y ) ( j , u , ν )} & i = j \\ {( {QK}_{intra} )}_{( i , x , y ) ( j , u , v )} = 0 & i \neq j\end{matrix} \qquad ( 6 )$$

On the other hand, the inter-image attention unit 1023 performs inter-image related processing. That is, processing is performed on the elements of (QK)_{(i, x, y)(j, u, v)} for which i≠j. In the present embodiment, when the difference between the image coordinates of the features referenced by the row and the column is 1 or less, the same value as the matrix QK is used, otherwise a value of 0 is used. That is, a matrix QKᵢₙₜₑᵣ representing inter-image attention is defined by the following expression (7).

$$\{ \begin{matrix}{( {QK}_{inter} )}_{( i , x , y ) j , u , ν )} = {( QK )}_{( i , x , y ) ( j , u , ν )} & i \neq j \vert x - u \vert \leq 1 and \vert y - v \vert \leq 1 \\ {( {QK}_{intra} )}_{( i , x , y ) ( j , u , v )} = 0 & otherwise\end{matrix} \qquad ( 7 )$$

In the present embodiment, the definitions in expressions (6) and (7) are used to perform a self-attention substitution process. That is, instead of the matrix QK represented in expression (3), a matrix QK′ represented in expression (8) below is inputted into the softmax function of expression (5).

$${DK}^{′} = {QK}_{intra} + {QK}_{inter} \qquad ( 8 )$$

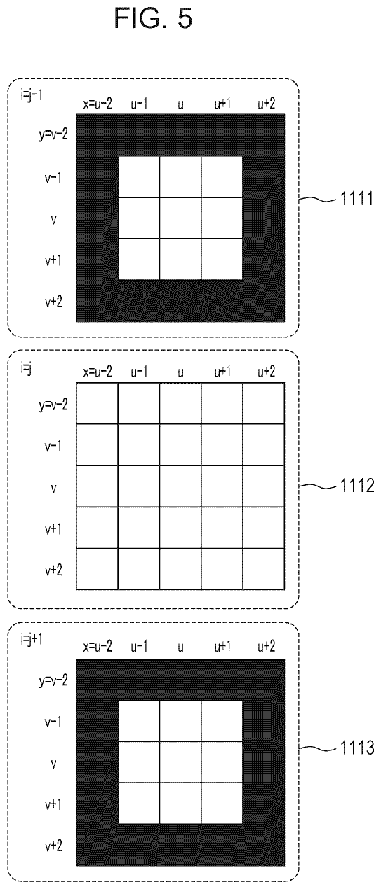

FIG. 5 is a diagram schematically illustrating a portion of the attention process of the matrix QK′ set forth in expression (8). As illustrated in the areas 1111 to 1113 of FIG. 5, when focusing on the region of the coordinates (u, v) of a certain j-th image, the regions on which to perform the attention process in relation to the focused region are illustrated in white. That is, the white portions correspond to the nonzero elements in the columns (j, u, v) of the matrix QK′.

Also, in the processing by the sub-transform units 1021, a process similar to Vision Transformer is performed in the other processing layers of the sub-modules included in the Vision Transformer encoder. Note that the other processing layer of the sub-modules are, for example, the normalization layer and the multi-layer perceptron (MLP) layer described in document 2.

In this way, in the present embodiment, by using attention as in expression (8), feature sequence generation is performed not only within each of the multiple images, but also between elements such as portions with close coordinates and portions with related features across images. Therefore, in a given image, the attention process is applied mainly to less blurry portions. In a given image showing multiple persons at the same time, the attention process is applied mainly to the region of a person that resembles a person shown in the other images, while the attention process is applied less to non-persons and persons other than the person of interest. This causes information to be extracted in a complementary manner, even from multiple images containing noise or the like, and features that are effective for the matching process can be generated.

In the present embodiment, when processing the relation between features in an attention process such as the processing of the matrix QK, for example, as in the method described in document 2, the processing is performed without using parameters that depend on the image size or the number of images. Examples of method that do not use parameters that depend on the image size or the number of images include the softmax function described in document 2 and the average pooling process described in Weihao Yu, Mi Luo, Pan Zhou, Chenyang Si, Yichen Zhou, Xinchao Wang, Jiashi Feng, Shuicheng Yan, MetaFormer is Actually What You Need for Vision, arXiv: 2111.11418 (hereinafter referred to as document 6). Since such processing is independent of the number of rows and columns in the matrix QK, the processing can be performed not only for any number of the multiple images 11 during training, but also for any number of images in the neighborhood.

In S203, the feature extraction unit 103 extracts features for use in the matching process from the feature sequence generated in S202. In the present embodiment, the features for use in the matching process are generated by applying the MLP layer described in document 2 to the features corresponding to a class token out of the feature sequence that is the output of the transform unit 102. It is assumed that the parameters of the MLP layer are optimized in advance by training. It is also assumed that in step S202, the class token is fixed as a token given attention so as to always obtain the same element as the matrix QK, as indicated in expression (9) below.

$$\{ \begin{matrix}{( {QK}_{inter} )}_{( cls ) ( j , u , v )} = {( QK )}_{( cls ) ( j , u , v )} \\ {( {QK}_{inter} )}_{( i , x , y ) ( cls )} = {( QK )}_{( i , x , y ) ( cls )} \\ {( {QK}_{intra} )}_{( cls ) ( cls )} = {( QK )}_{( cls ) ( cls )}\end{matrix} \qquad ( 9 )$$

In S204, the CPU 1201 determines whether to retain the features obtained in S203 or compare the obtained features with previously retained features. This determination involves determining whether to perform the retention process or the comparison process on the basis of the information acquired by the initial transform unit 101 in S201. If the result of the determination is to perform the retention process, the features generated in S204 are outputted to the feature retention unit 104 for similarity comparison and retained in the feature retention unit 104, after which the process ends. On the other hand, in the case of performing the comparison process, the features generated in S204 are outputted to the matching unit 105, and the process proceeds to S205.

In S205, the matching unit 105 identifies the person shown in the inputted multiple images 11 by comparison between the inputted features and the features retained in advance in the feature retention unit 104. In the present embodiment, to enable comparison of features, the initial transform unit 101, the transform unit 102, and the feature extraction unit 103 are trained in advance according to the method described in, for example, Jiankang Deng, Jia Guo, Niannan Xue, Stefanos Zafeiriou, ArcFace: Additive Angular Margin Loss for Deep Face Recognition, arXiv: 1801.07698 (document 1). Similarities between features obtained from training according to the method described in document 1 can be calculated by taking the inner product. The matching unit 105 calculates similarities between the features generated from the multiple images 11 and the features of all persons retained in advance, and outputs the person corresponding to the features with the highest similarity as a matching result. Note that if the highest similarity is below a threshold, an indication that no match could be found is outputted as a matching result. The similarity threshold at this point is set to a permissible failure rate (for example, FAR=0.0001), with the ROC curve created in advance during training.

By performing the matching process according to the procedure illustrated in FIG. 2, when generating features for a person in the multiple images 11, features are generated not only within each image, but also by accounting for portions with close coordinates and portions with related features across the multiple images 11. Therefore, information can be extracted in a complementary manner and features effective for the matching process can be generated, even for multiple images that include low-quality images with blurring or the like, low-resolution images from a surveillance camera or the like, and/or images of persons other than the person of interest. According to the present embodiment as described above, when performing the matching process using deep nets, a decrease in the matching accuracy due to noise and the like included in the multiple images 11 can be suppressed.

### Modification 1

In the present embodiment, the elements of the matrix QKᵢₙₜₑᵣ are defined by expression (7), but another method of defining the elements may also be used. For example, a token sequence for aggregation of attention (hereinafter, aggregate token sequence) may also be used. The aggregate token sequence is an extension of the class token described in document 2. A typical class token has at most one token per image frame. The aggregate token sequence in the present modification is a two-dimensional array of multiple class tokens to increase expressiveness in the spatial direction. The number of tokens is herein assumed to be one-fourth the number of features in a normal feature sequence for a single image. In other words, the aggregate token sequence is the same as halving each of the vertical and horizontal elements of the feature sequence. The number of feature dimensions for each token in the aggregate token sequence is the same as the number of feature dimensions for the class token and the tokens of other feature sequences. The same learnable parameters, such as the matrices W_{Q}, W_{K}, and W_{V}, the parameters of the MLP layer included in each sub-transform unit, and the like, are shared with other feature sequences. However, to improve performance, these parameters may also be newly learned as separate parameters instead of being shared. The sub-transform units 1021 accept the input of a feature sequence obtained by concatenating the aggregate token sequence and the feature sequence, and applies the attention process. This causes the attention process to be performed between the aggregate token sequence and the other feature sequences, and information from the other feature sequences is aggregated into the aggregate token sequence. Note that at the time of recognition, it may be necessary to give some kind of feature vector to the aggregate tokens as an initial value before starting the deep net processing. An optimal value for the initial value is found in advance by learning, in a similar manner to the initial value of the class token.

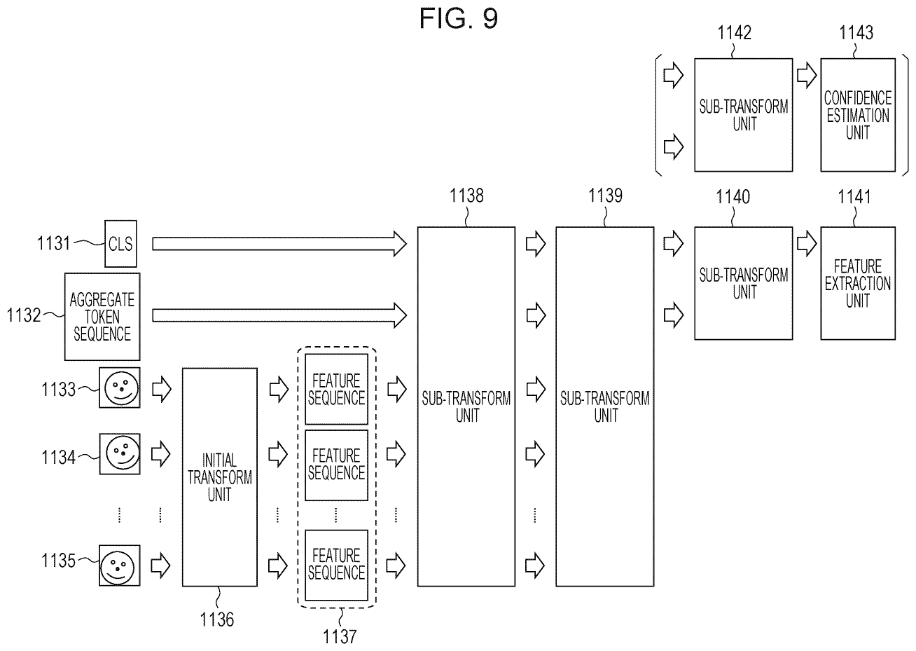

FIG. 9 is a diagram schematically illustrating a process using the aggregate token sequence. In FIG. 9, a class token 1131 and an aggregate token sequence 1132 are inputted into a sub-transform unit 1138. An initial transform unit 1136 processes inputted multiple images 1133-1135 and acquires feature sequences 1137. Sub-transform units 1138 and 1139 process the combined input of the class token, the aggregate token sequence, and the feature sequences 1137. On the other hand, a sub-transform unit 1140 processes only the class token and the aggregate token sequence. A feature extraction unit 1141 generates features for use in the matching process by applying the MLP layer described in document 2 to the features corresponding to the class token. In the case of using the aggregate token sequence, for example, the number of features inputted into the sub-transform unit 1140 from the sub-transform unit 1139 increases and the amount of given information increases.

In Modification 1, the features of the matrix QK_{(i, x, y)(j, u, v)} that correspond to i=1 or j=1 are processed as features of the aggregate token sequence. In Modification 1, each element of the matrix QKᵢₙₜₑᵣ in the aggregate token sequence is defined by the following expression (10).

$$\{ \begin{matrix}{( {QK}_{inter} )}_{( i , x , y ) j , u , ν )} = {( QK )}_{( i , x , y ) ( j , u , ν )} & i \neq j and i = 1 and x = ⌊ \frac{u}{2} ⌋ and y = ⌊ \frac{v}{2} ⌋ \\ {( {QK}_{inter} )}_{( i , x , y ) ( j , u , v )} = 0 & otherwise\end{matrix} \qquad ( 10 )$$

In the above expression, the symbol applied to u/2 and v/2 is the Gaussian symbol, and represents a function that truncates the fractional part. By setting the denominator to 2 in this way, the aggregate token sequence has the same number of elements as one-fourth the number of features for a single image.

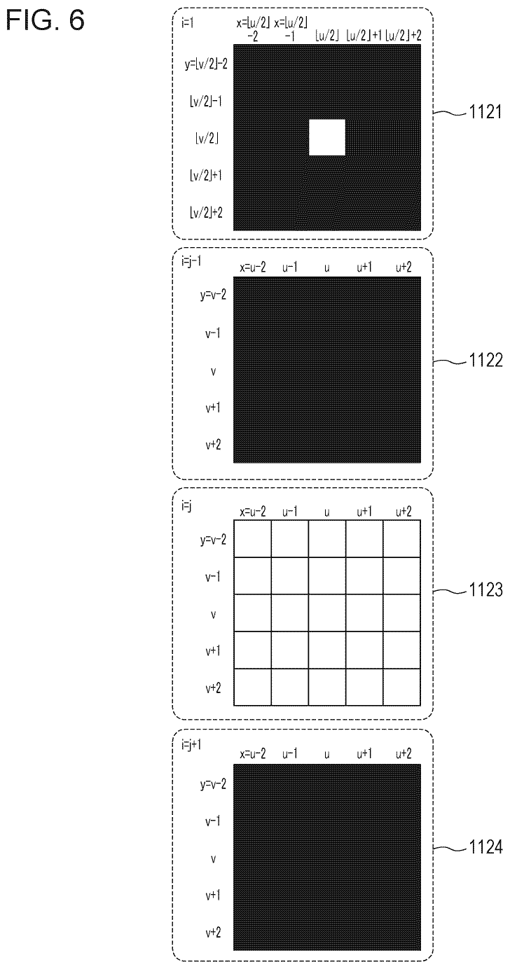

FIG. 6 is a diagram schematically illustrating a portion of the attention process of the matrix QK′ set forth in expression (8) using the matrix QKᵢₙₜₑᵣ defined by expression (10). As illustrated in the areas 1121 to 1124 of FIG. 6, when focusing on the region of the coordinates (u, v) of a certain j-th image, the regions on which to perform the attention process in relation to the focused region are illustrated in white. That is, the white portions correspond to the nonzero elements in the columns (j, u, v) of the matrix QK′. When the matrix QKᵢₙₜₑᵣ in expression (10) is used, the amount of compute only increases linearly with the number of inputted images. This can mitigate the increase in the amount of compute even when processing a large number of images.

In Modification 1, the aggregate token sequence is assumed to have the same number of elements as one-fourth the number of features for a single image, but the number of elements in the aggregate token sequence is not limited thereto. Given the method of defining elements in expression (10), the number of elements can be changed by setting the denominators of u/2 and v/2 in the expression to any other natural number. The aggregate token sequence may have the same number of elements as the number of features for a single image, or an aggregate token sequence with a number of elements greater than the number of features for a single image may be prepared. For example, the denominators can be set to 1 so that the number of features is the same as the number of elements in a feature sequence for a single image. The number of elements for each image corresponding to the elements of the aggregate token sequence may be varied in correspondence with the central and edge portions of a face. The sub-transform unit 1140 may also process only the class token to obtain features for use in matching, rather than processing both the class token and the aggregate token sequence. Conversely, a deep net that only uses the aggregate token sequence without using any class token is also conceivable. In this way, the class token and the aggregate token sequence may be implemented in any of various forms.

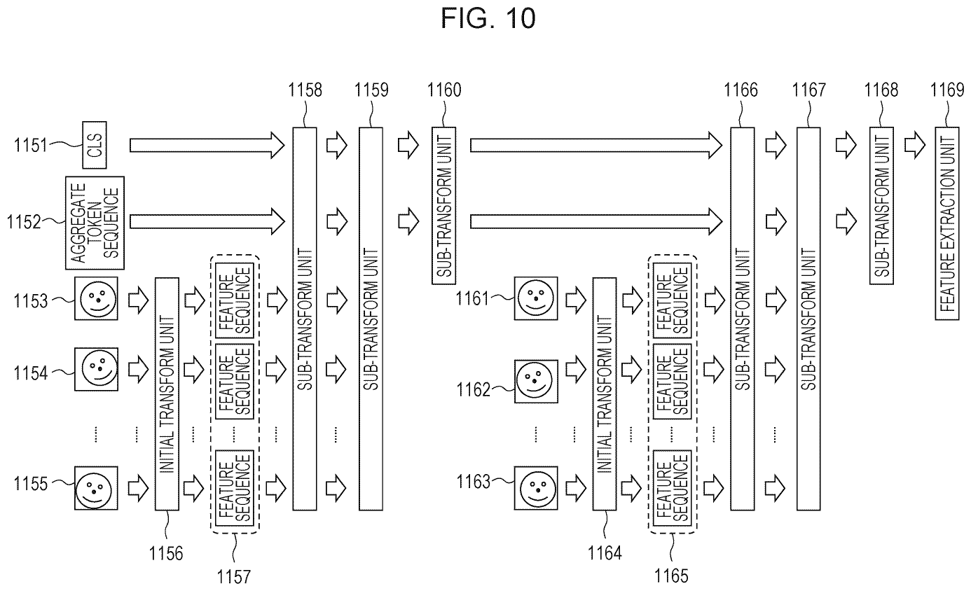

The multiple images 11 may also be inputted in multiple batches of any number of one or more images. FIG. 10 is a diagram schematically illustrating a process in a case where the multiple images 11 are divided up and inputted in multiple batches in the process using the aggregate token sequence. The class token 1151 and the aggregate token sequence 1152 are similar to those illustrated in FIG. 9. An initial transform unit 1156 processes inputted multiple images 1153-1155 and acquires feature sequences 1157. An initial transform unit 1164 similarly processes inputted multiple images 1161-1163 and acquires feature sequences 1165.

Sub-transform units 1158 and 1159 process the concatenated input of the class token, the aggregate token sequence, and the feature sequences 1157. A sub-transform unit 1160 processes only the class token and the aggregate token sequence. Sub-transform units 1166 and 1167 process the concatenated input of the class token and the aggregate token sequence processed by the sub-transform unit 1160 and the feature sequences 1165. A sub-transform unit 1168 processes only the class token and the aggregate token sequence. A feature extraction unit 1169 is similar to the one illustrated in FIG. 9.

In the example illustrated in FIG. 10, in particular, the number of features inputted into the sub-transform unit 1166 from the sub-transform unit 1160 increases and the amount of given information increases. Therefore, in the sub-transform unit 1166, the information obtained by the transform process up to the sub-transform unit 1160 can be aggregated efficiently. With a configuration that inputs the multiple images 11 in multiple batches in this way, the attention process can be performed by dividing up the input between the sub-transform unit 1158 and the sub-transform unit 1166. Moreover, the amount of compute in the sub-transform units is typically proportional to the square of the number of images, but by dividing up the input into multiple batches, highly accurate feature transformation is performed without performing attention processing across all images. This reduces the amount of compute in the sub-transform units to an amount less than the square of the number of images, allowing for time-efficient computation.

Using the above process also makes it possible to sequentially update the features for use in matching while sequentially inputting images in a time series, and perform matching after every update. With this arrangement, the features of the person of interest to be matched gradually change to features corresponding to high image quality. A method of matching can be adopted such that matching stops when matching is successful at some point, or when the person of interest goes out of frame.

Another conceivable form is to provide a separate mechanism (for example, the confidence estimation unit 1143 in FIG. 9) that can estimate in advance a level of confidence for the feature that are sequentially updated as described above, and to start matching once the level of confidence exceeds a prescribed value. Another conceivable form is to take the matching result at that time as the final determination result, and stop the feature updating and the matching. In this way, when multiple persons of interest to be matched are present in frame, computational resources can be allocated to the person of interest for whom more features need to be accumulated and updated. To estimate the level of confidence for the features, a sub-transform unit 1142 provided separately from the sub-transform unit 1140 for the purpose of outputting an estimate of the level of confidence may be provided upstream of the confidence estimation unit 1143, as illustrated in FIG. 9 for example. As an example, assume that the same features as the sub-transform unit 1140 are inputted into the sub-transform unit 1142. After the training of the deep nets other than the sub-transform unit 1142 is finished, confidence estimation training of the sub-transform unit 1142 is performed. Training data is prepared using different images from those used in the training so far, and feature extraction is performed while providing various numbers of image frames as the multiple images 11. Regression training of the sub-transform unit 1142 is performed by providing a supervisory value of 1 or 0 to indicate whether a face matching result based on a certain feature is correct or incorrect, and to perform regression training of the 1142 sub-transform.

### Modification 2

In the present embodiment, intra-image attention and inter-image attention are processed as an alternative to singular self-attention, but a different processing method may be applied. For example, softmax processing may be performed separately on each of the intra-image attention and the inter-image attention, and then the sum of the matrices may be taken. Further, for example, the intra-image attention and the inter-image attention may also be performed individually in order. Specifically, the value of the matrix QK is calculated within each image to determine the value of the attention according to the softmax function, and the feature sequence is updated. Thereafter, the feature sequence may be updated further by calculating the value of the matrix QK for each of close coordinates across images to determine the value of the attention according to the softmax function.

Different weight matrices (matrices W_{Q}, W_{K}, W_{V}) may also be used when calculating the matrix QKᵢₙₜᵣₐ and when calculating the matrix QKᵢₙₜₑᵣ. In this case, as long as the matrices QKᵢₙₜᵣₐ and QKᵢₙₜₑᵣ can be calculated, the weight matrices (matrices W_{Q}, W_{K}, W_{V}, etc.) may have varying numbers of elements, such as different numbers of rows and columns.

A process other than self-attention may also be applied. For example, attention processing may be performed by computational operations involving matrices retained as parameters, as with the method described in Hanxiao Liu, Zihang Dai, David R. So, Quoc V. Le, Pay Attention to MLPs, arXiv: 2105.08050 (hereinafter referred to as document 5). Specifically, the output of a Spatial Gating Unit may be handled as the matrix QK in the present embodiment. In this case, when a matrix P is retained as a parameter to calculate the matrix QK, PX (where X is the same as in expressions (1) and (2)) may be calculated instead of expression (3).

Features may also be extracted using a pooling layer, as with the method described in document 6. In other words, the locations where the pooling process is to be performed are limited as in expressions (6) and (7), and the non-processed portions are set to a value of 0. For example, when calculating the matrix QK in the case of using a k×k average pooling process, the result obtained by applying k×k average pooling to X (where X is the same as in expressions (1) and (2)) may be used instead of expression (3).

### Second Embodiment

The first embodiment describes an example of performing a matching process by inputting multiple images and generating features that account for not only intra-image attention but also inter-image attention. In contrast, the present embodiment describes a method for training the initial transform unit 101, the transform unit 102, and the feature extraction unit 103.

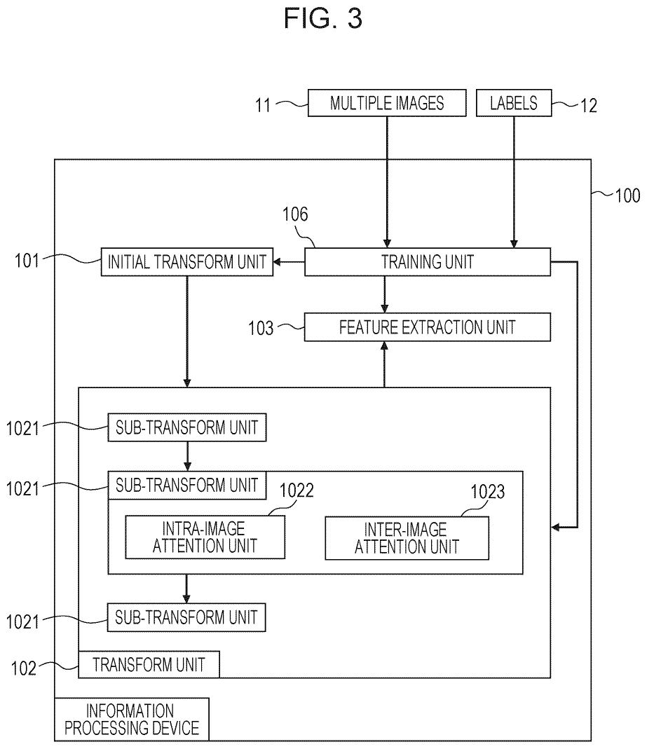

FIG. 3 is a block diagram illustrating an example of the functional configuration of an information processing device 100 for training an initial transform unit 101, a transform unit 102, and a feature extraction unit 103. Note that the initial transform unit 101 and the transform unit 102 have a configuration similar to the first embodiment.

The feature extraction unit 103 has an additional deep net that includes a likelihood transform for estimating the person shown in the multiple images 11 during training. The likelihood transform refers to a transform that calculates the inner product of the features processed by the feature extraction unit 103 and a representative vector, and calculates the likelihood of the person shown. The representative vector is set for each individual person included in the training data, and is a vector with the same number of dimensions as the features generated by the feature extraction unit 103.

A training unit 106 trains the initial transform unit 101, the transform unit 102, and the feature extraction unit 103 according to the method described in document 1 so that similarity can be calculated by taking the inner product between features.

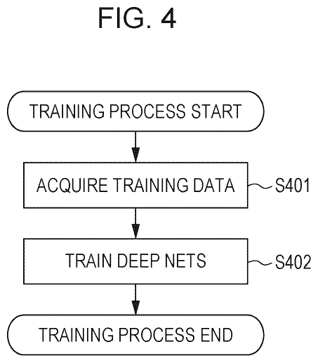

FIG. 4 is a flowchart illustrating an example of the procedure of a training process by the information processing device 100 in the present embodiment. First, in S401, the training unit 106 acquires training data. In this process, the training unit 106 first accepts the input of the multiple images 11 and a label 12. Like in the first embodiment, the multiple images 11 are multiple images in which the face of a person is shown, such as the results of tracking a person, for example. The label 12 is an ID corresponding to the person shown in the multiple images 11. To train the deep nets included in the initial transform unit 101, the transform unit 102, and the feature extraction unit 103, the training unit 106 acquires multiple pairs of the multiple images 11 and the label 12.

Next, in step S402, the training unit 106 trains the deep nets included in the initial transform unit 101, the transform unit 102, and the feature extraction unit 103. This process involves learning such that, when the multiple images 11 are inputted into the initial transform unit 101, the result of applying the softmax function to the likelihood of each person calculated from the feature extraction unit 103 matches the label 12. For the loss function and the optimization method, the functions indicated in document 1 are used. The features obtained as a result of the feature extraction unit 103 processing feature sequences obtained by the initial transform unit 101 and the transform unit 102 according to the method described in document 1 are features that are usable for the matching process.

By carrying out training according to the procedure as above, the deep nets can be trained to generate features that are effective for the matching process from the face of the person included in the multiple images 11.

### Modification 3

In the matching process, the features in the feature retention unit 104 are compared with the features that the feature extraction unit 103 outputs during the comparison process. On the other hand, either of the features may be obtained from a single image, that is, not the multiple images 11, according to the method described in document 1, which does not use an attention process. For example, a single high-quality frontal face image can be used as an image for use in registration, and multiple low-quality images taken multiple times by a surveillance camera or the like can be used as images for use in matching. In this situation, the number of dimensions of the features acquired according to the method described in document 1 is assumed to be equal to the number of dimensions of the features outputted by the feature extraction unit 103, to allow for comparison by taking the inner product. The deep nets may also have different configurations in this case. For example, one deep net that processes images is provided with an attention process, while the other deep net is not.

Also, in this case, the feature space may need to be configured in the same way to allow for outputting the similarity by taking the inner product between the features acquired according to the method described in document 1 and the features outputted by the feature extraction unit 103. Accordingly, as indicated in Japanese Patent Laid-Open No. 2022-182960, for example, the two models of the deep net according to the method described in document 1 and the deep net included in the information processing device 100 are trained at the same time. Alternatively, the parameters of one deep net are fixed, and the other model is trained.

In the configuration in FIG. 10 described in Modification 1, the output from not only the sub-transform unit 1168 that performs processing last, but also from the intermediate sub-transform unit 1160 or the like, may be used as input into the feature extraction unit 103. When applying the training method indicated in Modification 3 to such a configuration, training can be carried out so that features usable for the matching process can be outputted by the feature extraction unit 103 on the basis of the outputs from the multiple sub-transform units 1021. For example, in the example in FIG. 10, the processing up to the sub-transform unit 1160 is considered a first deep net, and the processing up to the sub-transform unit 1168 is considered a second deep net. The two models of these deep nets are then trained at the same time, or the parameters of one of the deep nets are fixed while the other model is trained, applying a method for configuring the feature space in the same way. Also, in the method described above, the number of images to be used by the first deep net may also be set to one image, for example.

Furthermore, when applying the method of Modification 3 to the configuration in FIG. 10 described above, a method that emphasizes computational speed or a method that emphasizes accuracy may be freely chosen. In the case of emphasizing computational speed, when computing features, the processing result up to, for example, the sub-transform unit 1160 is used as the input into the feature extraction unit 103. In the case of emphasizing accuracy, when computing features, the processing result up to, for example, the sub-transform unit 1168 is used as the input into the feature extraction unit 103.

### Modification 4

As described above, in the present embodiment, the deep nets included in the initial transform unit 101, the transform unit 102, and the feature extraction unit 103 are trained using the method described in document 1. In addition, the attention values generated by sub-transform unit 1021 may also be trained so as to be closer to organ positions, so that the features are generated in a way that better captures facial features.

In Modification 4, information about organ positions is used, and thus the inputted labels 12 contains not only the ID corresponding to the person but also an organ detection result for each of the multiple images 11. Note that organ detection results can be obtained according to the method described in document 3, and the organ detection results can be obtained by performing the detection process again on each of the multiple images 11. Modification 4 describes an example in which the five organs of the left eye, the right eye, the nose, the left corner of the mouth, and the right corner of the mouth are detected.

In Modification 4, the organ detection results described above are included as a label in part of the head of the attention result calculated by the sub-module included in the last encoder (the sub-transform unit 1021 that is applied last), and are used in S402 for the calculation of the loss function by the training unit 106.

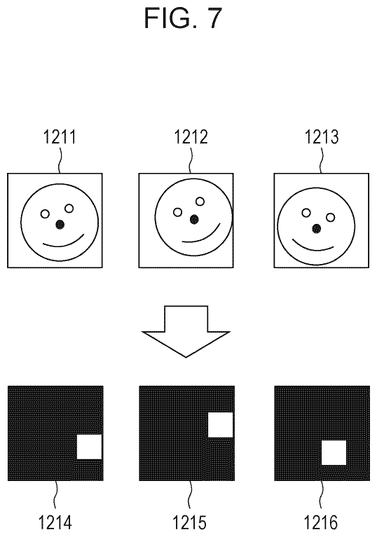

The organ detection results are transformed into a matrix whose elements are 0 or a constant k, corresponding to the features of each image, so that the results can be used as labels for the loss computation. For example, as illustrated in FIG. 7, assume that when given input of multiple images 1211 to 1213, respective detection results 1214 to 1216 for the left corner of the mouth are obtained. In Modification 4, a matrix with the same number of elements as the corresponding matrix QK is defined as an organ position matrix. In the organ position matrix, if the region of fixed size at coordinates (x, y) in the i-th image is the detection position of an organ (left corner of the mouth), the element whose row and column both correspond to (i, x, y) takes the value k, while the other elements take the value 0. Also, to make the organ position matrix serve as a label for an attention result, the value of k is defined to be the reciprocal of the number of detections of the left corner of the mouth so that the sum of the elements is 1. The loss function is then computed by comparing the organ position matrix with the result of computing the softmax function in expression (5). Note that the loss function is computed using a cross-entropy function.

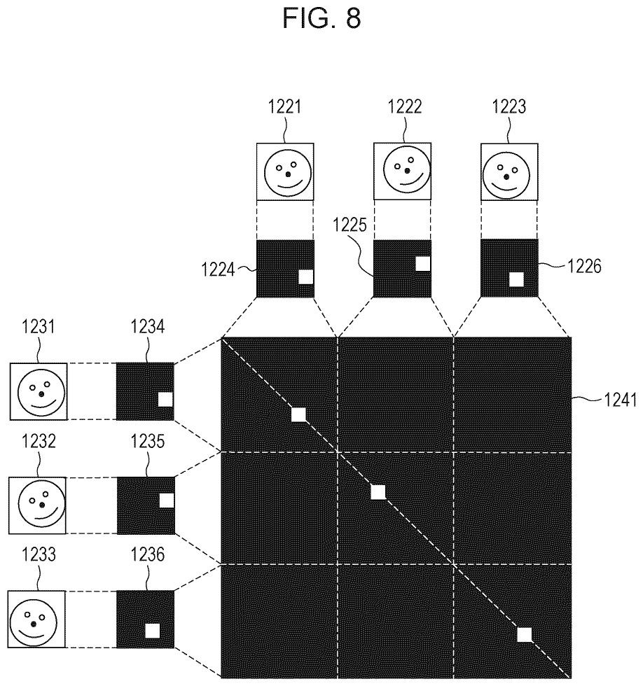

FIG. 8 is a diagram schematically illustrating the organ position matrix for the example illustrated in FIG. 7. In FIG. 8, assume that when given input of multiple images 1221 to 1223, respective detection results 1224 to 1226 for the left corner of the mouth are obtained. Similarly, assume that when given input of multiple images 1231 to 1233, respective detection results 1234 to 1236 for the left corner of the mouth are obtained. Also, in FIG. 8, the region 1241 is a schematic representation of the organ position matrix of the left corner of the mouth for the multiple images 11. As described above, the organ position matrix is a matrix in which the element whose row and column correspond to the coordinates of the left corner of the mouth detection position in the i-th image takes the value k, while the other elements take the value 0. In the example in FIG. 8, the portion of the diagonal component of the organ position matrix where the element corresponding to an organ detection position has a value of k corresponds to the white elements of the region 1241 in FIG. 8. The black elements of the region 1241 represent the other elements, which have a value of 0.

Organ position matrices are defined similarly for the other organs, and training is carried out by using the organ position matrices as labels for some of the heads of the attention results. In the training by the training unit 106, to evaluate the two loss functions together with the loss function described in document 1 in addition to the loss function using the organ position matrix, the loss function for organ position described above and the loss function described in document 1 are weighted and evaluated. As an example, the loss function for organ position is given a weight of 0.01, the loss function from document 1 is given a weight of 1, and the weighted sum of the loss function for organ position and the loss function from document 1 is evaluated as the final loss function. The deep nets included in the initial transform unit 101, the transform unit 102, and the feature extraction unit 103 are then trained.

As above, in Modification 4, the deep nets are trained to determine features while accounting for organ positions during processing, thus allowing for the extraction of features that are more effective for the process of matching a person's face.

### Modification 5

In the first and second embodiments, the multiple images 11 are obtained by extracting from each single video frame a single region showing the face of the person being tracked. In this context, it is assumed that, for example, the person detection and/or tracking are not stable due to poor shooting conditions, resulting in multiple candidates for the face of the person of interest. In such cases, the initial transform unit 101 normally obtains the multiple images 11 by extracting a single region with the highest face likelihood score from out of a single video frame. As a modified form, the multiple images 11 may also be obtained by inputting all regions inferred to be the face of the person of interest with a likelihood at or above a prescribed threshold, without being limited to a single region per video frame.

### Modification 6

In the first and second embodiments, the person of interest to be matched is detected/tracked using a single camera. As Modification 6, the initial transform unit 101 uses images of the person taken at the same time by multiple cameras as the multiple images 11. For example, the multiple images 11 may be generated by acquiring face regions that are estimated to be the same person according to the method in document 3 or the like, taking into account the spatial relationship of cameras. In this modification, the images acquired by any of the cameras are treated uniformly as the multiple images 11 without distinction, and thus an inter-image attention process similar to the attention process described thus far may be performed. As a result, it can be expected that features will be extracted with automatic adjustments applied, such as weak attention being applied to images that do not show the face due to the angle between the camera and the person, and thus are not useful for feature extraction.

As another form, inter-image attention may be split depending on whether the images are from the same camera. For example, the attention process may be divided into two parts: attention between images taken at different times by the same camera (hereinafter, Inter1); and attention between images taken at the same time by different cameras (hereinafter, Inter2). One example of achieving the above is a process like the following. For example, first, the elements of the (QK)_{(i, x, y)(j, u, v)} attention matrix used in the first embodiment are extended. Specifically, the elements of the attention matrix between the features of a face image taken by a camera c1 at time t1 and the features of a face image taken by a camera c2 at time t2 are denoted as (QK)_{(c1, t1, x, y)(c2, t2, x, y)}. In this case, the attention matrix QKᵢₙₜₑᵣ₁ of Inter1 is an attention matrix whose elements are non-zero if c1=c2, t1≠t2, and the difference between image coordinates is a prescribed value n or less, and zero if otherwise. The attention matrix QKᵢₙₜₑᵣ₂ of Inter2 is an attention matrix whose elements are non-zero if c1≠c2, t1=t2, and the difference between image coordinates is a prescribed value n or less, and zero if otherwise. Thus, in Modification 6, the following expression (11) may be used instead of expression (8) used in the first embodiment.

$${QK}^{′} = {QK}_{intra} + {QK}_{inter 1} + {QK}_{inter 2} \qquad ( 11 )$$

In this form, features for use in matching are generated after performing an encoding process using intra-image attention, inter-image attention between cameras, and attention between images taken at different times, as described above. In another form, these attention processes may also be used for the purpose of generating higher-quality images.

### Modification 7

As Modification 7, multiple camera images taken at the same time are used, in a similar manner to Modification 6. In this case, the initial transform unit 101 uses N images obtained from a stereo camera or a multi-view stereo camera as the multiple images 11. Extracting features from different-camera images captured at the same time in this way allows for the generation of features that are more accurate than features extracted from a single image each. Furthermore, it can be expected that features with high discriminative power reflecting the three-dimensional characteristics of the face will be generated. However, for accurate training and matching using three-dimensional features, it is desirable to capture images of the subject with the same camera arrangement (similar disparity) during training and matching.

### Modification 8

In the attention process in the embodiments described above, it is not necessary to fix the number of the multiple images 11 to a single value. It is also not necessary to use the exact same number of images during training and recognition. In general, the number of images to be obtained will vary depending on the results of face detection and/or person tracking. Accordingly, it is conceivable to have the initial transform unit 101 vary the number of the multiple images 11 dynamically according to the number of face images obtained as a result of the processing upstream. The number of the multiple images 11 can be determined dynamically such that, for example, when there is a small number of face images, all of the images are used to generate features, and when there is a large number of images, a maximum number of images t is determined and the images going back from the most recent image to the t-th image are used. As another example, processing can also be performed such that when a large number of persons appear in frame and there are many persons to be matched at the same time, the number of images to be used per person is reduced, otherwise the maximum number of images is used.

According to the present disclosure, features that are effective for a matching process can be extracted from low-quality and/or noisy images.

### OTHER EMBODIMENTS

The present disclosure is also achievable by a process of supplying a program for achieving one or more functions of the embodiments described above to a system or a device via a network or a storage medium, and having one or more processors in a computer of the system or device read out and execute the program. The present disclosure is also achievable by a circuit (for example, an ASIC) that achieves the one or more functions.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. An information processing device comprising:
an acquirer configured to acquire a feature sequence from each image in a plurality of images containing a common object; and
a feature extractor configured to extract representative features of the object in the plurality of images from the feature sequence acquired by the acquirer, wherein
the acquirer is configured to acquire the feature sequence based on intra-image information within each image in the plurality of images and inter-image information across the plurality of images.

2. The information processing device according to claim 1, wherein
the acquirer is configured to generate the inter-image information based on a relation between at least some elements of the feature sequence.

3. The information processing device according to claim 2, wherein
the acquirer is configured to generate the inter-image information based on elements of the feature sequence that have coordinates which are the same or are in proximity to each other in different images.

4. The information processing device according to claim 2, wherein
the feature sequence includes a token sequence for aggregation of attention, and
the acquirer is configured to further generate information based on the token sequence for aggregation as the inter-image information.

5. The information processing device according to claim 4, wherein
the token sequence for aggregation has a different number of elements than the number of elements of the feature sequence for a single one of the images.

6. The information processing device according to claim 4, wherein
the token sequence for aggregation has the same number of elements as the number of elements of the feature sequence for a single one of the images.

7. The information processing device according to claim 4, wherein
the acquirer is configured to divide up the plurality of images into multiple batches for input, and generate inter-image information with respect to each of the multiple batches.

8. The information processing device according to claim 7, wherein
the acquirer is configured to perform a process based on feature sequences obtained from the plurality of images divided up into multiple batches and the token sequence for aggregation.

9. The information processing device according to claim 7, wherein
the acquirer is configured to acquire the feature sequence using an amount of compute that is less than the square of the number of images in the plurality of images.

10. The information processing device according to claim 1, wherein
the acquirer is configured to acquire the feature sequence by not using parameters that depend on image size or the number of images.

11. The information processing device according to claim 10, wherein
the acquirer is configured to acquire the feature sequence by using the softmax function.

12. The information processing device according to claim 10, wherein
the acquirer is configured to acquire the feature sequence by using average pooling.

13. The information processing device according to claim 1, further comprising:
a trainer configured to train the acquirer and the feature extractor.

14. The information processing device according to claim 13, wherein
the object is the face of a person, and
the trainer is configured to train the acquirer and the feature extractor by incorporating an organ detection result regarding the face of the person.

15. The information processing device according to claim 13, wherein
the trainer is configured to train the acquirer and the feature extractor to have a feature space matching that of a deep net that calculates features from a single image.

16. The information processing device according to claim 15, further comprising:
a matcher configured to match the object by comparing features obtained by the deep net to features extracted by the feature extractor.

17. The information processing device according to claim 16, wherein
the acquirer further includes a selector configured to select a method for calculating the feature sequence according to processing speed or processing accuracy.

18. The information processing device according to claim 1, wherein
each image in the plurality of images is obtained by tracking the object.

19. The information processing device according to claim 1, wherein
the plurality of images is made up of images obtained by extracting candidate regions of the object from multiple locations.

20. The information processing device according to claim 1, wherein
the plurality of images includes images captured by a plurality of cameras at different angles.

21. The information processing device according to claim 1, wherein
the acquirer is configured to dynamically change the number of images to be acquired as the plurality of images.

22. The information processing device according to claim 1, further comprising:
a confidence estimator configured to estimate a level of confidence for the features.

23. The information processing device according to claim 16, wherein
the matcher is configured to perform matching by using, as input, features generated by a deep net and other features outputted by another deep net with a different configuration from the deep net.

24. A method for controlling an information processing device, the method comprising:
acquiring a feature sequence from each image in a plurality of images containing a common object; and
extracting representative features of the object in the plurality of images from the feature sequence acquired in the acquiring, wherein
the acquiring involves acquiring the feature sequence based on intra-image information within each image in the plurality of images and inter-image information across the plurality of images.

25. A non-transitory computer readable medium storing a program causing a computer to execute a process comprising:
acquiring a feature sequence from each image in a plurality of images containing a common object; and
extracting representative features of the object in the plurality of images from the feature sequence acquired in the acquiring, wherein
the acquiring involves acquiring the feature sequence based on intra-image information within each image in the plurality of images and inter-image information across the plurality of images.
